(19) United States
(12) Patent Application Publication
(10) Pub. No.: US 2011/0032502 A1
(43) Pub. Date: Feb. 10, 2011

(54) POLARIZATION EVALUATION MASK, EXPOSURE DEVICE, AND POLARIZATION EVALUATION METHOD

(76) Inventor: Hiroshi NOMURA, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/852,201

(22) Filed: Aug. 6, 2010

(30) Foreign Application Priority Data
Aug. 7, 2009 (JP) 2009-184642

(51) Int. Cl. G03B 27/72; G01J 4/00

(52) U.S. Cl. 355/71; 356/364

(57) ABSTRACT

Polarization evaluation mask according to one mode includes a transparent substrate, a light shielding portion, plural quarter-wavelength plates, and plural polarizers. The light shielding portion is formed on the transparent substrate and has plural openings therein. Plural quarter-wavelength plates are formed to cover at least one opening. Fast axes of the quarter-wavelength plates are different in azimuth by a certain angle. Plural polarizers are disposed upstream of the quarter-wavelength plates with respect to the illumination light and formed to overlay the quarter-wavelength plates and cover at least one of the openings. Transmission axes of the polarizers are different in azimuth by a certain angle. The plural openings are provided with different combinations of an azimuth, of the polarizer and an azimuth of the quarter-wavelength plate from one another.

### CROSS REFERENCE TO RELATED APPLICATIONS

This application is based on and claims the benefit of priority from prior Japanese Patent Application No. 2009-184642, filed on Aug. 7, 2009, the entire contents of which are incorporated herein by reference.

### BACKGROUND

1. Field

Embodiments described herein relate generally to a polarization evaluation mask used for evaluating a polarization property of an exposure device, an exposure device, and a polarization evaluation method.

2. Description of the Related Art

Recently known in the field of semiconductor exposure devices in order to improve the resolution of minute patterns is a so-called liquid immersion exposure device which immerses the space between a bottommost projection lens and a semiconductor substrate with liquid to realize a very high NA projection lens having numerical aperture of 1 or higher. However, such an increase in the numerical aperture has given rise to a problem that the resolving power of the devices lowers depending on a polarization state of illumination light. Hence, polarized illumination techniques are being developed which make a polarization state of illumination light have a specific distribution in a secondary light source plane. Techniques of evaluating the polarization state are also being developed.

### BRIEF DESCRIPTION OF THE DRAWINGS

FIG. 1 is a schematic diagram of an exposure device including a photomask according to an embodiment.

FIG. 2 is a top view of a polarization evaluation mask 70.

FIG. 3 is a cross section of a polarization element unit 72A.

FIG. 4 is a top view of polarization element units 72A to 72D.

FIG. 5 is a diagram for explaining a Poincare sphere.

### DETAILED DESCRIPTION

Conventionally, a Jones vector or a Stokes parameter has been generally used to express a polarization state of light. A Jones vector expresses an electric field vector E as the following (Expression 1), by using amplitudes aₓ and a_{y}, and a phase difference δ.

$$E = ( \begin{matrix}{E}_{x} \\ {E}_{y}\end{matrix} ) = {e}^{iω t} ( \begin{matrix}{a}_{x} {e}^{{iϕ}_{x}} \\ {a}_{y} {e}^{{iϕ}_{y}}\end{matrix} ) = {e}^{i ( ω t + {ϕ}_{x} )} ( \begin{matrix}{a}_{x} \\ {a}_{y} {e}^{iδ}\end{matrix} ) \qquad ( Expression 1 )$$

A Jones matrix is used to express a characteristic of an optical element when completely-polarized light that can be expressed by a Jones vector passes through the optical element and is influenced by the optical element. A Jones matrix may be represented by the following (Expression 2). Since each component of a Jones vector is represented by a complex number, each component of a Jones matrix is also represented by a complex number.

$$J = ( \begin{matrix}{j}_{xx} & {j}_{xy} \\ {j}_{yx} & {j}_{yy}\end{matrix} ) \qquad ( Expression 2 )$$

Since a Jones vector is an expression using an electric field vector, it can be advantageously used without any modification in general optical simulators, etc. A specific example of a Jones vector does not give any intuitive suggestion regarding the characteristic of the polarization of light such as whether it expresses linearly-polarized light or elliptically-polarized light, or which direction the main axis of polarized light is directed to. Likewise, a specific example of a Jones matrix does not provide any intuitive comprehension as to how the matrix converts the polarization state. Hence, a Jones vector and a Jones matrix have a drawback in that they are difficult to use for designing optical systems and for analyzing factors of errors in optical systems. Furthermore, a Jones vector or a Jones matrix handles only the completely-polarized light, and cannot handle general partially-polarized light including unpolarized components. Therefore, when measuring or analyzing polarized light, a Stokes parameter and a Mueller matrix are generally used, except for special cases.

A Stokes parameter is a tensor composed of four components s₀, s₁, s₂, and s₃. When it is defined that the component s₀ represents the total intensity of light, the component s₁ represents the intensity of a linearly-polarized light component of 0°, the component s₂ represents the intensity of a linearly-polarized light component of 45°, and the component s₃ represents the intensity of rightward circularly-polarized light component, a Stokes parameter of completely-polarized light is represented by the following (Expression 3). As can be seen, each component of Stokes parameter is a measurable real number, whereas each component of Jones vector is represented by a complex number.

$$S = ( \begin{matrix}{s}_{0} \\ {s}_{1} \\ {s}_{2} \\ {s}_{3}\end{matrix} ) = ( \begin{matrix}{a}_{x}^{2} + {a}_{y}^{2} \\ {a}_{x}^{2} - {a}_{y}^{2} \\ 2 {a}_{x} {a}_{y} cos δ \\ 2 {a}_{x} {a}_{y} sin δ\end{matrix} ) \qquad ( Expression 3 )$$

The components s₁, s₂, and s₃ of the Stokes parameter correspond to x-axis, y-axis, and z-axis of a Poincare sphere shown in FIG. 5 respectively, and any polarization state is expressed by one point on the surface of the Poincare sphere. The longitude of the Poincare sphere corresponds to double the azimuth θ of polarized light, and the latitude corresponds to double the ellipticity angle ε of polarized light. That is, the points on the equator of the Poincare sphere represent linearly-polarized light, and points closer to the poles of the Poincare sphere represent more circularly-polarized light whereas points farther from the poles represent more elliptically-polarized light, The polarity of polarized light is rightward in the north hemisphere and leftward in the south hemisphere.

A relationship represented by the following (Expression 4) is established among the components s₀, s₁, s₂, and s₃. The right-hand side of the (Expression 4) represents the intensity of completely-polarized light components, and the value obtained by subtracting the right-hand side from the left-hand side corresponds to the intensity of an unpolarized light component.

s₀≧(s₁²+s₂²+s₃²)^{1/2} (Expression 4)

The above (Expression 4) is expressed by the Poincare sphere of FIG. 5. Since the right-hand side of the (Expression 4) corresponds to the radius of the Poincare sphere, the Poincare sphere becomes the largest when it expresses completely-polarized light. In this case, the radius becomes equal to s₀. As the amount of the unpolarized light component becomes larger, the Poincare sphere becomes smaller, and converges to the origin when the light becomes completely-unpolarized light.

A Mueller matrix is represented by the following (Expression 5). A Muller matrix and a Stokes parameter have a relationship similar to a relationship between a Jones vector and a Jones matrix,

$$M = ( \begin{matrix}{m}_{00} & {m}_{01} & {m}_{02} & {m}_{03} \\ {m}_{10} & {m}_{11} & {m}_{12} & {m}_{13} \\ {m}_{20} & {m}_{21} & {m}_{22} & {m}_{23} \\ {m}_{30} & {m}_{31} & {m}_{32} & {m}_{33}\end{matrix} ) \qquad ( Expression 5 )$$

That is, when a Mueller matrix of a given optical element is defined as M, Stokes parameter of incident light entering the optical element is defined as S, and Stokes parameter of outgoing light exiting the optical element is defined as S′, the relationship among them is represented by the following (Expression 6).

$${S}^{′} = MS \\ ( \begin{matrix}{s}_{0}^{′} \\ {s}_{1}^{′} \\ {s}_{2}^{′} \\ {s}_{3}^{′}\end{matrix} ) = ( \begin{matrix}{m}_{00} & {m}_{01} & {m}_{02} & {m}_{03} \\ {m}_{10} & {m}_{11} & {m}_{12} & {m}_{13} \\ {m}_{20} & {m}_{21} & {m}_{22} & {m}_{23} \\ {m}_{30} & {m}_{31} & {m}_{32} & {m}_{33}\end{matrix} ) ( \begin{matrix}{s}_{0} \\ {s}_{1} \\ {s}_{2} \\ {s}_{3}\end{matrix} ) \qquad ( Expression 6 )$$

Mueller matrices of ordinary optical elements is already known. For example, a linear polarizer P having an azimuth θ has a Mueller matrix represented by the following (Expression 7), and a quarter-wavelength plate Q having an azimuth θ has a Mueller matrix represented by the following (Expression 8).

$$\begin{matrix}{P}_{θ} = \frac{1}{2} ( \begin{matrix}1 & cos 2 θ & sin 2 θ & 0 \\ cos 2 θ & {cos}^{2} 2 θ & cos 2 θ sin 2 θ & 0 \\ sin 2 θ & cos 2 θ sin 2 θ & {sin}^{2} 2 θ & 0 \\ 0 & 0 & 0 & 0\end{matrix} ) & ( Expression 7 ) \\ {Q}_{θ} = ( \begin{matrix}1 & 0 & 0 & 0 \\ 0 & {cos}^{2} 2 θ & sin 2 θ cos 2 θ & - sin 2 θ \\ 0 & sin 2 θ cos 2 θ & {sin}^{2} 2 θ & cos 2 θ \\ 0 & sin 2 θ & - cos 2 θ & 0\end{matrix} ) & ( Expression 8 )\end{matrix}$$

A polarizer P′ having light transmittance x² at an azimuth θ has a Mueller matrix represented by the following (Expression 9), and a quarter-wavelength plate Q′ having a retardation error δ at an azimuth θ has a Mueller matrix represented by the following (Expression 10).

$$\begin{matrix} ( Expression 9 ) \\ {P}_{θ}^{′} = \frac{1}{2} ( \begin{matrix}1 + {x}^{2} & ( 1 - {x}^{2} ) cos 2 θ & ( 1 - {x}^{2} ) sin 2 θ & 0 \\ ( 1 - {x}^{2} ) cos 2 θ & \begin{matrix}( 1 + {x}^{2} ) {cos}^{2} 2 θ + \\ 2 x {sin}^{2} 2 θ\end{matrix} & ( 1 - {x}^{2} ) cos 2 θ sin 2 θ & 0 \\ ( 1 - {x}^{2} ) sin 2 θ & ( 1 - {x}^{2} ) cos 2 θ sin 2 θ & \begin{matrix}( 1 + {x}^{2} ) {sin}^{2} 2 θ + \\ 2 x {cos}^{2} 2 θ\end{matrix} & 0 \\ 0 & 0 & 0 & 2 x\end{matrix} ) \\ ( Expression 10 ) \\ {Q}_{θ}^{′} = ( \begin{matrix}1 & 0 & 0 & 0 \\ 0 & 1 - ( 1 + sin δ ) {sin}^{2} 2 θ & ( 1 + sin δ ) sin 2 θ cos 2 θ & - cos δ sin 2 θ \\ 0 & ( 1 + sin δ ) sin 2 θ cos 2 θ & 1 - ( 1 + sin δ ) {cos}^{2} 2 θ & cos δ cos 2 θ \\ 0 & cos δsin 2 θ & - cos δ cos 2 θ & - sin δ\end{matrix} )\end{matrix}$$

A Polarization state is evaluated by taking into consideration (Expression 1) to (Expression 10) given above. Publicly-known polarization evaluation methods include the following three types. The first polarization evaluation method evaluates a polarization state of light that reach a wafer stage. The second polarization evaluation method measures a polarization state of light that illuminates a mask. The third polarization evaluation method determines a Mueller matrix of a projection lens existing between a polarization mask and a polarization monitor.

The first polarization evaluation method uses a test mask having a certain phase shift pattern, and evaluates the balance of a polarization state in a secondary light source plane, based on a resist pattern formed by exposing the test mask. An alternative embodiment of the first polarization evaluation method evaluates a difference in aberration caused by change in a polarization plate. A mask used in this alternative embodiment of the first polarization evaluation method includes two types of polarization plates. The two types of polarization plates may be formed on a back surface of a test mask including two of known aberration evaluation masks, or on a pellicle attached to a known photomask for dust prevention. By using these two type of polarization plates, the alternative embodiment measures a difference in aberration caused by change in a polarization plate.

A polarization measuring mask used in the second polarization evaluation method includes a wide viewing-angle quarter wavelength plate and a thin-plate polarizer formed on a test mask in this order when seen from the upstream side of an illumination light. The polarization measuring mask has windows corresponding to sixteen combinations of a fast axis of the wavelength plate and a transmission axis of the polarizer. The azimuths of the fast axes and the transmission axes in the combinations differ by 45°. A polarization state of the light illuminating the mask are measured by observing an image formed on an image sensor mounted on a wafer stage caused by an illumination light that passes through these sixteen windows.

The third polarization evaluation method sets a polarization state of illumination light six conditions which are diagonal or orthogonal to one another on the Poincare sphere, and determines a Mueller matrix by using a polarization monitor on a wafer stage and a polarization measuring mask.

However, among the six polarization states necessary for the third polarization evaluation method, at least two polarization states are hard to generate by an actual exposure device. Hence, it becomes necessary to add a polarizing element inside an illumination lens of the exposure device, which makes it difficult for a user of the exposure device to implement the third polarization evaluation method by himself. Even if he could implement it, it is necessary to measure the six polarization states individually, which requires a very long measurement time. That is, development of a method that can easily determine a Mueller matrix of a projection lens to evaluate a polarized state of light is highly demanded.

A polarization evaluation mask according to one mode is used for evaluating a polarization state of a projection lens in an exposure device. The mask is disposed upstream of the projection lens with respect to an illumination light thereof. The mask comprises a transparent substrate, a light shielding portion, a plurality of quarter-wavelength plates, and a plurality of polarizers. The light shielding portion is formed on the transparent substrate and has a plurality of openings therein. The plurality of quarter-wavelength plates are formed to cover at least one opening. Fast axes of the quarter-wavelength plates are different in azimuth by a certain angle. The plurality of polarizers are disposed upstream of the quarter-wavelength plates with respect to the illumination light. The plurality of polarizers are formed to overlay the quarter-wavelength plates and cover at least one opening. Transmission axes of the polarizers are different in azimuth by a certain angle. The plurality of openings are provided with different combinations of an azimuth of the polarizer and an azimuth of the quarter-wavelength plate from one another,

An exposure device according to one mode includes a projection lens, and a polarization evaluation mask, The polarization evaluation mask is disposed upstream of the projection lens with respect to an illumination light thereof to evaluate a polarization state of the projection lens. The mask comprises a transparent substrate, a light shielding portion, a plurality of quarter-wavelength plates, and a plurality of polarizers. The light shielding portion is formed on the transparent substrate and has a plurality of openings therein. The plurality of quarter-wavelength plates are formed to cover at least one opening. Fast axes of the quarter-wavelength plates are different in azimuth by a certain angle. The plurality of polarizers are disposed upstream of the quarter-wavelength plates with respect to the illumination light. The plurality of polarizers are formed to overlay the quarter-wavelength plates and cover at least one opening. Transmission axes of the polarizers are different in azimuth by a certain angle . The plurality of openings are provided with a different combinations of an azimuth of the polarizer and an azimuth of the quarter wavelength plate from one another.

A polarization evaluation method according to one mode is a method of evaluating a polarization state of a projection lens of an exposure device. In the polarization evaluation method, first, a light shielding portion comprising an opening, a quarter-wavelength plate to cover the opening, a polarizer to be overlaid on the quarter-wavelength plate are positioned from a downstream side of illumination light, at closer positions to the illumination light than the projection lens is. Next, the azimuth of the fast axis of the quarter-wavelength plate and the azimuth of the transmission axis of the polarizer are changed at predetermined angular intervals to generate plural combinations of the azimuths, and the intensity of light obtained by letting the illumination light transmit through the polarizer under each combination is measured. Then, a Mueller matrix is calculated based on the intensities.

A polarization evaluation mask and a polarization evaluation method according to one embodiment will be explained below with reference to the drawings.

### EMBODIMENT

### Configuration

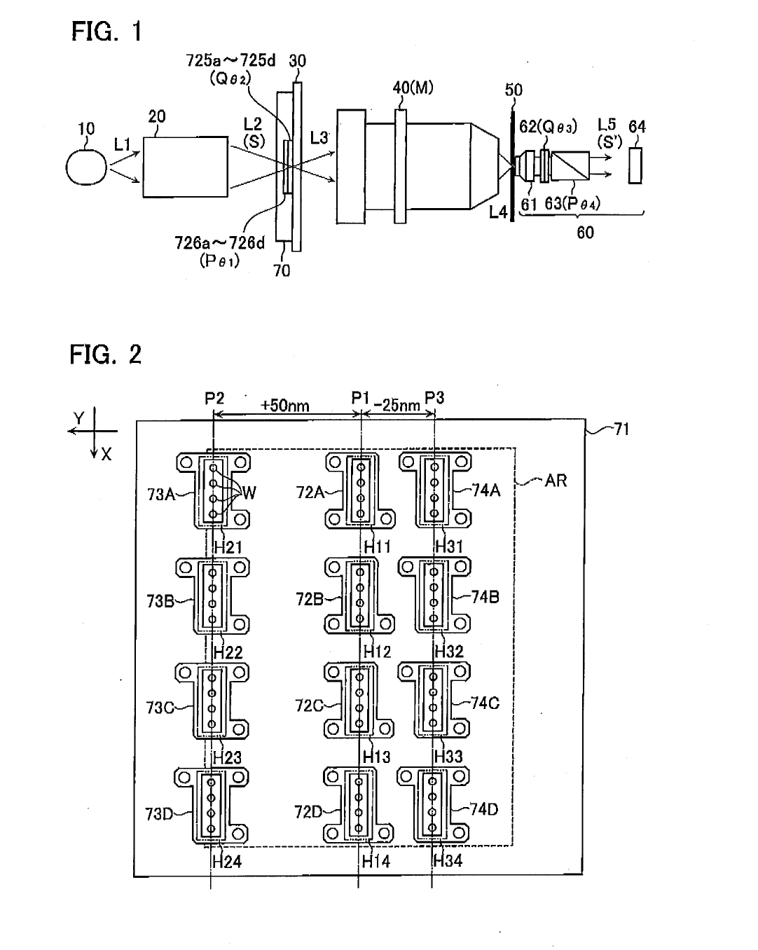

FIG. 1 is a schematic diagram of an exposure device including a photomask according to an embodiment of the present invention. The exposure device according to this embodiment irradiates a substrate with illumination light to form a certain pattern on the substrate. The exposure device identifies a Mueller matrix of a projection lens 40 (a polarization state of light) described later. As shown in FIG. 1, the exposure device includes a light source device 10, an illumination lens 20, a photomask stage 30, a projection lens 40, a wafer stage 50, and a polarization monitor 60.

The light source device 10 irradiates the illumination lens 20 with illumination light L1. The illumination lens 20 converts the illumination light L1 to a desired luminance distribution and a desired polarization states to generate light L2, and illuminates the photomask stage 30 with the light L2. The photomask stage 30 is configured such that it may mount a photomask thereon. The photomask stage 30 has a polarization evaluation mask 70 (a Mueller matrix measuring mask) thereon. The polarization evaluation mask 70 mounted on the photomask stage 30 converts the illuminated light L2 to a desired luminance distribution and a desired polarization state to generate light L3, and irradiates the projection lens 40 with the light L3. The projection lens 40 converts the light L3 to a desired luminance distribution and desired polarization states to generate light L4, and irradiates the wafer stage 50 with the light L4. The wafer stage 50 is configured to mount a substrate thereon. The polarization monitor 60 is configured to convert the light L4 irradiated to the wafer stage 50 into light L5 and to be able to measure the polarization state of the light L5.

As shown in FIG. 1, the polarization monitor 60 includes a collimator 61, a quarter-wavelength plate 62, a prism-type polarizer 63, and a detector 64.

The collimator 61 collimates the light irradiated to the wafer stage 50, and guides the light into the quarter-wavelength plate 62.

The quarter-wavelength plate 62 is configured to be rotatable to polarize the light L4 to a polarization state corresponding to the rotation angle. That is, the azimuth θ3 of the fast axis of the quarter-wavelength plate 62 can be changed by an angle j. The quarter-wavelength plate 62 guides the polarized light into the prism-type polarizer 63. The quarter-wavelength plate 62 includes two parallel plates having approximately the same thickness stocked therein. This structure allows the quarter-wavelength plate 62 to rotate with ignorably small deviation from the light axis.

The prism-type polarizer 63 is fixed. Specifically, the azimuth θ4 of the transmission axis of the prism-type polarizer 63 is fixed at an angle Θ. The prism-type polarizer 63 guides a polarized light L5 resulting from the light L4 into the detector 64.

The detector 64 detects the intensity of the light L5 provided from the prism-type polarizer 63.

Next, the configuration of the polarization evaluation mask 70 will be explained with reference to FIG. 2. FIG. 2 is a top view of the polarization evaluation mask 70. The polarization evaluation mask 70 is used for evaluating a Mueller matrix (a polarization state) of a projection lens 40 in an exposure device. The polarization evaluation mask 70 is disposed upstream of the projection lens 40 with respect to an illumination light thereof. As shown in FIG. 2, the polarization evaluation mask 70 includes a substrate 71 and polarization element units 72A to 72D, 73A to 73D, and 74A to 74D.

As shown in FIG. 2, the substrate 71 has a shape of a rectangular plate. The substrate 71 has, at a first position P1, four through holes H11 to H14 arranged in line at a predetermined pitch in an X direction (a scan direction). The substrate 71 has, at a second position P2, four through holes H21 to H24 arranged in line at a predetermined pitch in the X direction. The substrate 71 further has at a third position P3, four through holes H31 to H34 arranged in line at a predetermined pitch in the X direction. The second position P2 is distanced from the first position P1 by +50 mm in a Y direction (a direction orthogonal to the X direction). The third position P3 is distanced from the first position P1 by −25 mm in the Y direction.

As shown in FIG. 2, the polarization element units 72A to 72D, 73A to 73D, and 74A to 74D are formed within an exposure region AR having a rectangular shape (e.g., 132 mm×104 mm) on the substrate 71. The polarization element units 72A to 72D are fitted inside the through holes H11 to H14 in the substrate 71. The polarization element units 73A to 73D are fitted inside the through holes H21 to H24 in the substrate 71. The polarization element units 74A to 74D are fitted inside the through holes H31 to H34 in the substrate 71.

That is, the polarization element units 72A to 72D are arranged in line at a predetermined pitch in the X direction at the first position PI. The polarization element units 73A to 73D are arranged in line at a predetermined pitch in the X direction at the position P2. The polarization element units 74A to 74D are arranged in line at a predetermined pitch in the X direction at the position P3.

The polarization element units 72A to 72D, 73A to 73D, and 74A to 74D each have four windows W through which light transmits. In other words, the polarization element units 72A to 72D have a total of sixteen windows W at the first position P1, The polarization element units 73A to 73D have a total of sixteen windows W at the second position P2. The polarization element units 74A to 74D have a total of sixteen windows W at the third position P3.

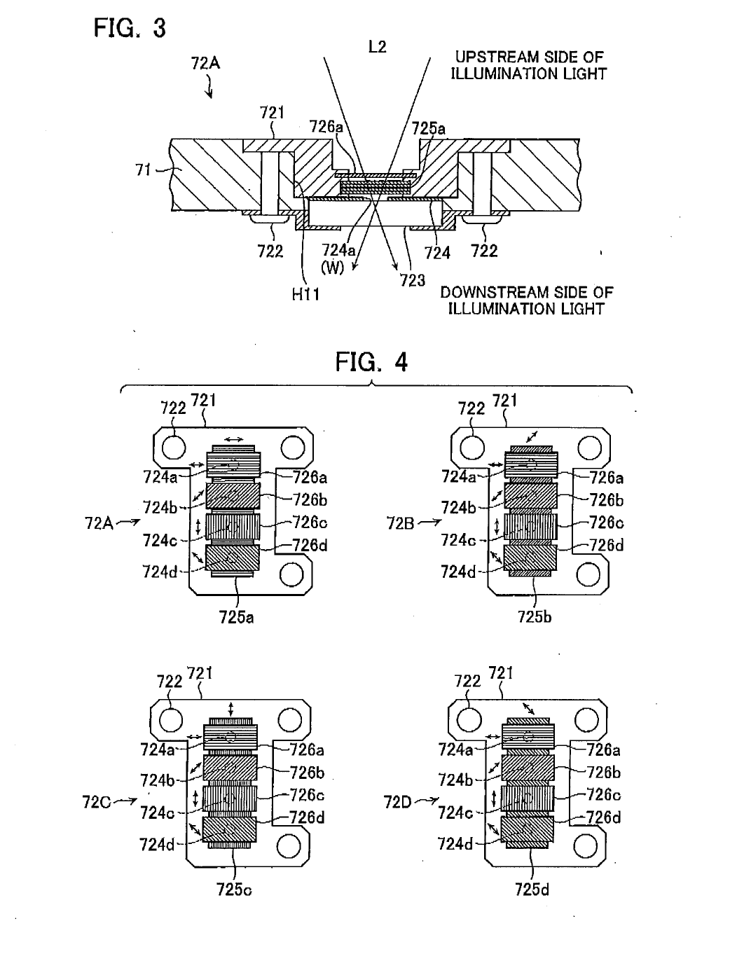

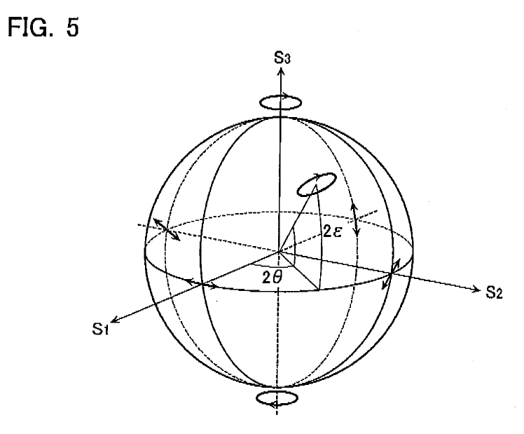

Next, the configuration of the polarization element units 72A to 72D will be explained with reference to FIG. 3 and FIG. 4. FIG. 3 is a cross sectional view of the polarization element unit 72A. Cross sections of the polarization element units 72B to 72D are the same as shown in FIG. 3, and hence not illustrated. FIG. 4 is a top view of the polarization element units 72A to 72D.

The polarization element unit 72A will first be explained. As shown in FIG. 3, the polarization element unit 72A includes a housing 721, screws 722, a transparent substrate 723, a light shielding portion 724, a wide viewing-angle quarter-wavelength plate 725a, and thin-plate polarizers 726a to 726d.

As shown in FIG. 3, the housing 721 is positioned in the through hole H11 formed in the substrate 71. The housing 721 is fixed in the substrate 71 by the screws 722 so as not to protrude from the back surface of the substrate 71. The housing 721 supports the transparent substrate 723, the light shielding portion 724, the wide viewing-angle quarter-wavelength plate 725a, and the thin-plate polarizers 726a to 726d.

As shown in FIG. 3, the transparent substrate 723 is configured to allow the light L2 to transmit therethrough. The transparent substrate 723 is made of, for example, quartz.

As shown in FIG. 3, the light shielding portion 724 is formed on one side of the transparent substrate 723 that is on the upstream side of the illumination light to shield the light L2 partially. The light shielding portion 724 has openings 724a to 724d (corresponding to the windows W described above). The openings 724a to 72 4d are arranged side by side at a predetermined pitch in the X direction. The light shielding portion 724 is made of chromium. The diameter of the openings 724a to 724d is, for example, 1 mm.

The wide viewing-angle quarter-wavelength plate 725a is formed to cover the openings 724a to 724d as shown in FIG. 3 and FIG. 4. The azimuth 62 of the fast axis of the wide viewing-angle quarter-wavelength plate 725a is set to 0°. The wide viewing-angle quarter-wavelength plate 725a is composed of a quarter-wavelength plate including two crystal plates, and a zero wavelength plate including two crystal plates. The quarter-wavelength plate including two crystal plates is made of crystallized quartz which is a positive uniaxial crystal. The zero wavelength plate including two crystal plates is made of lanthanum fluoride which is a negative uniaxial crystal. Crystallized quartz and lanthanum fluoride have substantially equal absolute values of nₑ−n₀ (nₑ means an extraordinary ray refractive index, while n₀ means an ordinary ray refractive index.) and substantially equal average refraction indexes. Therefore, combination of crystallized quartz and lanthanum fluoride may provide a quarter-wavelength plate with a stable performance even if an incident angle of incident light thereto changes over a wide range.

As shown in FIG. 3 and FIG. 4, the thin-plate polarizers 726a to 726d are disposed upstream of the wide viewing-angle quarter-wavelength plate 725a with respect to the illumination light, and formed to overlay the wide viewing-angle quarter-wavelength plate 725a and cover the openings 724a to 724d. The azimuths θ1 of the transmission axes of the thin-plate polarizers 726a to 726d differ to one another by 45° (θ1=0°, 45°, 90°, 135°). The thin-plate polarizers 726a to 726d are made of calcite, formed into the shape of a thin slice such that the light axis thereof is oriented in-plane, and polished to a thickness of 80 μm. The thin-plate polarizers 726a to 726d are formed to have a smaller size than the wide viewing-angle quarter-wavelength plate 725a.

Next, the polarization element unit 72B will be explained. As shown in FIG. 4, the polarization element unit 72B includes a wide viewing-angle quarter-wavelength plate 725b. The azimuth θ2 of the fast axis of the wide viewing-angle quarter-wavelength plate 725b is set to 45°. The configuration of the polarization element unit 72B is the same as the polarization element unit 72A in the other respects.

Next, the polarization element unit 72C will be explained. As shown in FIG. 4, the polarization element unit 72C includes a wide viewing-angle quarter-wavelength plate 725c. The azimuth θ2 of the fast axis of the wide viewing-angle quarter-wavelength plate 725c is set to 90°. The configuration of the polarization element unit 72C is the same as the polarization element unit 72A in the other respects.

Next, the polarization element unit 72D will be explained. As shown in FIG. 4, the polarization element unit 72D includes a wide viewing-angle quarter-wavelength plate 725d. The azimuth θ2 of the fast axis of the wide viewing-angle quarter-wavelength plate 725d is set to 135° (−45°). The configuration of the polarization element unit 72D is the same as the polarization element unit 72A in the other respects.

That is, the wide viewing-angle quarter-wavelength plates 725a to 725d are set such that the azimuths θ2 of their fast axes differ by 45°. Hence, the polarization element units 72A to 72D which includes the wide viewing-angle quarter-wavelength plates 725a to 725d and the thin-plate polarizers 726a to 726d, can generate sixteen types of polarized light.

The polarization element units 73A to 73D and 74A to 74D have the same configuration as the polarization element units 72A to 72D.

### [First Calculation Method]

Next, a first method of calculating a Mueller matrix will be explained. The first calculation method calculates a Mueller matrix by performing measurement under four combinations out of the sixteen combinations of the azimuth θ1 and the azimuth θ2. For example, the first calculation method can calculate a Mueller matrix by measuring only one polarization element unit 72A.

To begin with, the arrangement of the optical system from the polarization evaluation mask 70 to the detector 64 can be represented by the following (Expression 11). In the (Expression 11), the Stokes parameter of the light L2 irradiated to the polarization evaluation mask 70 is defined as S, and the Stokes parameter of the light L5 irradiated to the detector 64 is defined as S′. The Mueller matrix of the thin-plate polarizers 726a to 726d is defined as P′_{θ1}. The Mueller matrix of the wide viewing-angle quarter-wavelength plates 725a to 725d is defined as Q′_{θ2}. The Mueller matrix of the quarter-wavelength plate 62 is defined as Q_{θ3}. The Mueller matrix of the prism-type polarizer 63 is defined as P_{θ4}. The Mueller matrix of the projection lens 40 is defined as M (see FIG. 1).

S′=P_{θ4}Q_{θ3}MQ′_{θ2}P′_{θ1}S (Expression 11)

Here, the azimuths θ1 of the transmission axes of the thin-plate polarizers 726a to 726d provided on the polarization evaluation mask 70 and the azimuths θ2 of the fast axes of the wide viewing-angle quarter-wavelength plates 725a to 725d provided thereon are set at 45° intervals. The azimuth θ3 of the fast axes of the quarter-wavelength plate 62 in the polarization monitor 60 can be set to be variable by an angle j. The azimuth θ4 of the prism-type polarizer 63 is fixed at the angle φ. Hence, there are a total of sixteen combinations of the azimuth θ1 and the azimuth θ2 as shown below.

θ1=0°, 45°, 90°, 135° (−45°)
θ2=0°, 45°, 90°, 135° (−45°)
θ3=j (variable)
θ4=φ (fixed)

When it is defined that the amplitude transmittance of the thin-plate polarizers 726a to 726d of the polarization evaluation mask 70 is x, and the retardation error of the wide viewing-angle quarter-wavelength plates 725a to 725d at the azimuth θ2 is δ_{θ2}, the light intensity I_{θ2,θ1}(j) (=s′₀) at the detector 64 under each combination is represented by the following (Expression 12).

$${I}_{θ2 , θ1} ( ϕ ) = \frac{1}{4} [ \begin{matrix}{α}_{θ2 , θ1} {H}_{0} ( ϕ ) + {β}_{θ2 , θ1} {H}_{1} ( ϕ ) + \\ {γ}_{θ2 , θ1} {H}_{2} ( ϕ ) + {κ}_{θ2 , θ1} {H}_{3} ( ϕ )\end{matrix} ] \qquad ( Expression 12 )$$

The coefficients indicated in the above (Expression 12) may be expressed by the following (Expression 13) to (Expressions 29).

$$\begin{matrix}\begin{matrix}{H}_{j} ( ϕ ) = [ {m}_{0 j} + \frac{{m}_{1 j}}{2} cos 2 Θ + \frac{{m}_{2 j}}{2} sin 2 Θ ] + \\ [ {m}_{3 j} sin 2 Θ ] cos 2 ϕ + [ - {m}_{3 j} cos 2 Θ ] sin 2 ϕ + \\ [ \frac{{m}_{1 j}}{2} cos 2 Θ - \frac{{m}_{2 j}}{2} sin 2 Θ ] cos 4 ϕ + \\ [ \frac{{m}_{1 j}}{2} sin 2 Θ + \frac{{m}_{2 j}}{2} cos 2 Θ ] sin 4 ϕ \\ = {a}_{j} + {b}_{j} cos 4 ϕ + {c}_{j} sin 4 ϕ + \\ {d}_{j} cos 2 ϕ + {e}_{j} sin 2 ϕ\end{matrix} & ( Expression 13 ) \\ \{ \begin{matrix}{α}_{0 , 0} = ( 1 + {χ}^{2} ) {s}_{0} + ( 1 - {χ}^{2} ) {s}_{1} \\ {β}_{0 , 0} = ( 1 - {χ}^{2} ) {s}_{0} + ( 1 + {χ}^{2} ) {s}_{1} \\ {γ}_{0 , 0} = - ( 2 χ sin {δ}_{0} ) {s}_{2} + ( 2 χ cos {δ}_{0} ) {s}_{3} \\ {κ}_{0 , 0} = - ( 2 χ cos {δ}_{0} ) {s}_{2} - ( 2 χ sin {δ}_{0} ) {s}_{3}\end{matrix} & ( Expressions 14 ) \\ \{ \begin{matrix}{α}_{0 , 45} = ( 1 + {χ}^{2} ) {s}_{0} + ( 1 - {χ}^{2} ) {s}_{2} \\ {β}_{0 , 45} = 2 χ {s}_{1} \\ {γ}_{0 , 45} = - [ ( 1 - {χ}^{2} ) sin {δ}_{0} ] {s}_{0} - [ ( 1 + {χ}^{2} ) sin {δ}_{0} ] {s}_{2} + ( 2 χ cos {δ}_{0} ) {s}_{3} \\ {κ}_{0 , 45} = - [ ( 1 - {χ}^{2} ) cos {δ}_{0} ] {s}_{0} - [ ( 1 + {χ}^{2} ) cos {δ}_{0} ] {s}_{2} - ( 2 χ sin {δ}_{0} ) {s}_{3}\end{matrix} & ( Expressions 15 ) \\ \{ \begin{matrix}{α}_{0 , 90} = ( 1 + {χ}^{2} ) {s}_{0} - ( 1 - {χ}^{2} ) {s}_{1} \\ {β}_{0 , 90} = - ( 1 - {χ}^{2} ) {s}_{0} + ( 1 + {χ}^{2} ) {s}_{1} \\ {γ}_{0 , 90} = - ( 2 χ sin {δ}_{0} ) {s}_{2} + ( 2 χ cos {δ}_{0} ) {s}_{3} \\ {κ}_{0 , 90} = - ( 2 χ cos {δ}_{0} ) {s}_{2} - ( 2 χ sin {δ}_{0} ) {s}_{3}\end{matrix} & ( Expressions 16 ) \\ \{ \begin{matrix}{α}_{0 , - 45} = ( 1 + {χ}^{2} ) {s}_{0} ( 1 - {χ}^{2} ) {s}_{2} \\ {β}_{0 , - 45} = 2 χ {s}_{1} \\ {γ}_{0 , - 45} = [ ( 1 - {χ}^{2} ) sin {δ}_{0} ] {s}_{0} - [ ( 1 + {χ}^{2} ) sin {δ}_{0} ] {s}_{2} + ( 2 χ cos {δ}_{0} ) {s}_{3} \\ {κ}_{0 , - 45} = [ ( 1 - {χ}^{2} ) cos {δ}_{0} ] {s}_{0} - [ ( 1 + {χ}^{2} ) cos {δ}_{0} ] {s}_{2} - ( 2 χ sin {δ}_{0} ) {s}_{3}\end{matrix} & ( Expressions 17 ) \\ \{ \begin{matrix}{α}_{45 , 0} = ( 1 + {χ}^{2} ) {s}_{0} + ( 1 - {χ}^{2} ) {s}_{1} \\ {β}_{45 , 0} = - [ ( 1 - {χ}^{2} ) sin {δ}_{45} ] {s}_{0} - [ ( 1 + {χ}^{2} ) sin {δ}_{45} ] {s}_{1} - ( 2 χ cos {δ}_{45} ) {s}_{1} \\ {γ}_{45 , 0} = 2 χ {s}_{2} \\ {κ}_{45 , 0} = [ ( 1 - {χ}^{2} ) cos {δ}_{45} ] {s}_{0} + [ ( 1 + {χ}^{2} ) sin {δ}_{45} ] {s}_{1} - ( 2 χ cos {δ}_{45} ) {s}_{3}\end{matrix} & ( Expressions 18 ) \\ \{ \begin{matrix}{α}_{45 , 45} = ( 1 + {χ}^{2} ) {s}_{0} + ( 1 - {χ}^{2} ) {s}_{2} \\ {β}_{45 , 45} = - ( 2 χ sin {δ}_{45} ) {s}_{1} - ( 2 χ cos {δ}_{45} ) {s}_{3} \\ {γ}_{45 , 45} = ( 1 - {χ}^{2} ) {s}_{0} + ( 1 + {χ}^{2} ) {s}_{2} \\ {κ}_{45 , 45} = ( 2 χ cos {δ}_{45} ) {s}_{1} - ( 2 χ sin {δ}_{45} ) {s}_{3}\end{matrix} & ( Expressions 19 ) \\ \{ \begin{matrix}{α}_{45 , 90} = ( 1 + {χ}^{2} ) {s}_{0} - ( 1 - {χ}^{2} ) {s}_{1} \\ {β}_{45 , 90} = [ ( 1 - {χ}^{2} ) sin {δ}_{45} ] {s}_{0} - {[ ( 1 + {χ}^{2} ) sin {δ}_{45} ]}_{1} - ( 2 χ cos {δ}_{45} ) {s}_{3} \\ {γ}_{45 , 90} = 2 χ {s}_{2} \\ {κ}_{45 , 90} = - [ ( 1 - {χ}^{2} ) cos {δ}_{45} ] {s}_{0} + {[ ( 1 + {χ}^{2} ) cos {δ}_{45} ]}_{1} - ( 2 χ sin {δ}_{45} ) {s}_{3}\end{matrix} & ( Expressions 20 ) \\ \{ \begin{matrix}{α}_{45 , - 45} = ( 1 + {χ}^{2} ) {s}_{0} - ( 1 - {χ}^{2} ) {s}_{2} \\ {β}_{45 , - 45} = - ( 2 χ sin {δ}_{45} ) {s}_{1} ( 2 χ cos {δ}_{45} ) {s}_{3} \\ {γ}_{45 , - 45} = - ( 1 - {χ}^{2} ) {s}_{0} + ( 1 + {χ}^{2} ) {s}_{2} \\ {κ}_{45 , - 45} = ( 2 χ cos {δ}_{45} ) {s}_{1} - ( 2 χ sin {δ}_{45} ) {s}_{3}\end{matrix} & ( Expressions 21 ) \\ \{ \begin{matrix}{α}_{90 , 0} = ( 1 + {χ}^{2} ) {s}_{0} + ( 1 - {χ}^{2} ) {s}_{1} \\ {β}_{90 , 0} = ( 1 - {χ}^{2} ) {s}_{0} + ( 1 + {χ}^{2} ) {s}_{1} \\ {γ}_{90 , 0} = - ( 2 χ sin {δ}_{90} ) {s}_{2} - ( 2 χ cos {δ}_{90} ) {s}_{3} \\ {κ}_{90 , 0} = ( 2 χ cos {δ}_{90} ) {s}_{2} - ( 2 χ sin {δ}_{90} ) {s}_{3}\end{matrix} & ( Expressions 22 ) \\ \{ \begin{matrix}{α}_{90 , 45} = ( 1 + {χ}^{2} ) {s}_{0} + ( 1 - {χ}^{2} ) {s}_{2} \\ {β}_{90 , 45} = 2 χ {s}_{1} \\ {γ}_{90 , 45} = - [ ( 1 - {χ}^{2} ) sin {δ}_{90} ] {s}_{0} - [ ( 1 + {χ}^{2} ) sin {δ}_{90} ] {s}_{2} - ( 2 χ cos {δ}_{90} ) {s}_{3} \\ {κ}_{90 , 45} = [ ( 1 - {χ}^{2} ) cos {δ}_{90} ] {s}_{0} + [ ( 1 + {χ}^{2} ) cos {δ}_{90} ] {s}_{2} - ( 2 χ sin {δ}_{90} ) {s}_{3}\end{matrix} & ( Expressions 23 ) \\ \{ \begin{matrix}{α}_{90 , 90} = ( 1 + {χ}^{2} ) {s}_{0} - ( 1 - {χ}^{2} ) {s}_{1} \\ {β}_{90 , 90} = - ( 1 - {χ}^{2} ) {s}_{0} + ( 1 + {χ}^{2} ) {s}_{1} \\ {γ}_{90 , 90} = - ( 2 χ sin {δ}_{90} ) {s}_{2} - ( 2 χ cos {δ}_{90} ) {s}_{3} \\ {κ}_{90 , 90} = ( 2 χ cos {δ}_{90} ) {s}_{2} - ( 2 χ sin {δ}_{90} ) {s}_{3}\end{matrix} & ( Expressions 24 ) \\ \{ \begin{matrix}{α}_{90 , - 45} = ( 1 + {χ}^{2} ) {s}_{0} - ( 1 - {χ}^{2} ) {s}_{2} \\ {β}_{90 , - 45} = 2 χ {s}_{1} \\ {γ}_{90 , - 45} = [ ( 1 - {χ}^{2} ) sin {δ}_{90} ] {s}_{0} - [ ( 1 + {χ}^{2} ) sin {δ}_{90} ] {s}_{2} - ( 2 χ cos {δ}_{90} ) {s}_{3} \\ {κ}_{90 , - 45} = - [ ( 1 - {χ}^{2} ) cos {δ}_{90} ] {s}_{0} + [ ( 1 + {χ}^{2} ) cos {δ}_{90} ] {s}_{2} - ( 2 χ sin {δ}_{90} ) {s}_{3}\end{matrix} & ( Expressions 25 ) \\ \{ \begin{matrix}{α}_{- 45 , 0} = ( 1 + {χ}^{2} ) {s}_{0} + ( 1 - {χ}^{2} ) {s}_{1} \\ {β}_{- 45 , 0} = - [ ( 1 - {χ}^{2} ) sin {δ}_{- 45} ] {s}_{0} - [ ( 1 + {χ}^{2} ) sin {δ}_{- 45} ] {s}_{2} + ( 2 χ cos {δ}_{- 45} ) {s}_{3} \\ {γ}_{- 45 , 0} = 2 χ {s}_{2} \\ {κ}_{- 45 , 0} = - [ ( 1 - {χ}^{2} ) cos {δ}_{- 45} ] {s}_{0} - [ ( 1 + {χ}^{2} ) cos {δ}_{- 45} ] {s}_{2} - ( 2 χ sin {δ}_{- 45} ) {s}_{3}\end{matrix} & ( Expressions 26 ) \\ \{ \begin{matrix}{α}_{- 45 , 45} = ( 1 + {χ}^{2} ) {s}_{0} + ( 1 - {χ}^{2} ) {s}_{2} \\ {β}_{- 45 , 45} = - ( 2 χ sin {δ}_{- 45} ) {s}_{1} + ( 2 χ cos {δ}_{- 45} ) {s}_{3} \\ {γ}_{- 45 , 45} = - ( 1 - {χ}^{2} ) {s}_{0} + ( 1 + {χ}^{2} ) {s}_{2} \\ {κ}_{- 45 , 45} = ( 2 χ cos {δ}_{- 45} ) {s}_{1} - ( 2 χ sin {δ}_{- 45} ) {s}_{3}\end{matrix} & ( Expressions 27 ) \\ \{ \begin{matrix}{α}_{- 45 , 90} = ( 1 + {χ}^{2} ) {s}_{0} - ( 1 - {χ}^{2} ) {s}_{1} \\ {β}_{- 45 , 90} = [ ( 1 - {χ}^{2} ) sin {δ}_{- 45} ] {s}_{0} - [ ( 1 + {χ}^{2} ) sin {δ}_{- 45} ] {s}_{2} + ( 2 χ cos {δ}_{- 45} ) {s}_{3} \\ {γ}_{- 45 , 90} = \\ {κ}_{- 45 , 90} = [ ( 1 - {χ}^{2} ) cos {δ}_{- 45} ] {s}_{0} - [ ( 1 + {χ}^{2} ) cos {δ}_{- 45} ] {s}_{2} - ( 2 χ sin {δ}_{- 45} ) {s}_{3}\end{matrix} & ( Expressions 28 ) \\ \{ \begin{matrix}{α}_{- 45 , - 45} = ( 1 + {χ}^{2} ) {s}_{0} - ( 1 - {χ}^{2} ) {s}_{2} \\ {β}_{- 45 , - 45} = - ( 2 χ sin {δ}_{- 45} ) {s}_{1} + ( 2 χ cos {δ}_{- 45} ) {s}_{3} \\ {γ}_{- 45 , - 45} = - ( 1 - {χ}^{2} ) {s}_{0} + ( 1 + {χ}^{2} ) {s}_{2} \\ {κ}_{- 45 , - 45} = - ( 2 χ cos {δ}_{- 45} ) {s}_{1} - ( 2 χ sin {δ}_{- 45} ) {s}_{3}\end{matrix} & ( Expressions 29 )\end{matrix}$$

In the above expressions, the polarization state S (s₀, s₁, s₂, and s₃) of the illumination light L2, the amplitude transmittance x of the thin-plate polarizers 726a to 726d, and the retardation error δ_{θ2} of the wide viewing-angle quarter-wavelength plates 725a to 725d can be measured in advance. Therefore, all the coefficients represented by the (Expressions 14) to (Expressions 29) can be calculated. Here, it is necessary to perform measurement under only at least four combinations out of the sixteen combinations of the azimuth θ1 and the azimuth θ2. In the measurement, the intensity I_{θ1,θ2}(j) of the transmitted light is measured by the detector 64 while the azimuth θ3 (=j) of the quarter-wavelength plate 62 mounted in the polarization monitor 60 is changed at desired angular intervals. Subsequently, H₀(j), H₁(j), H₂(j), and H₃(j) in the (Expression 13) is calculated in a similar manner to solving a simultaneous equation. Next, Fourier analysis is performed on H₀(j), H₁(j), H₂(j), and H₃(j) respectively to calculate the coefficients aᵢ of a constant term, bᵢ of a term of cos(2 j), cᵢ of a term of sin(2 j), dᵢ of a term of cos(4 j), and eᵢ of a term of sin(4 j). As a result, all components of the Mueller matrix of the projection lens 40 can be determined. Here, i=0, 1, 2, 3.

For example, Fourier analysis on H₀(j) can calculate four components (m₀₀, m₁₀, m₂₀, m₃₀) of the Mueller matrix, which are represented by the following (Expressions 30).

$${m}_{0 j} = {a}_{j} - {b}_{j} cos 4 Θ - {c}_{j} sin 4 Θ \\ {m}_{1 j} = 2 {b}_{j} cos 2 Θ + 2 {c}_{j} sin 2 Θ \\ {m}_{2 j} = - 2 {b}_{j} sin 2 Θ + 2 {c}_{j} cos 2 Θ \\ {m}_{3 j} = \{ \begin{matrix}\sqrt{{d}_{j}^{2} + {e}_{j}^{2}} … {d}_{j} sin 2 Θ \geq 0 \\ - \sqrt{{d}_{j}^{2} + {e}_{j}^{2}} … {d}_{j} sin 2 Θ < 0\end{matrix} \qquad ( Expressions 30 )$$

Fourier analysis on H₁(j), H₂(j), and H₃(j) results similarly to H₀(j). Components (m₀₁, m₁₁, m₂₁, m₃₁) can be calculated from H₁(j). Components (m₀₂, m₁₂, mm₂₂, m₃₂) can be calculated from H₂(j). Components (m₀₃, m₁₃, m₂₃, m₃₃) can be calculated from H₃(j). The fixed azimuth θ4 (=Θ) of the prism-type polarizer 63 mounted in the polarization monitor 60 is represented by the following (Expression 31), and can be calculated from the result of this measurement.

$$Θ = \frac{1}{2} {tan}^{- 1} ( - \frac{{d}_{t}}{{e}_{t}} ) \qquad ( Expression 31 )$$

### [Second Calculation Method]

Next, a second method of calculating a Mueller matrix will be explained. The second calculation method calculates a Mueller matrix by performing measurement under all the sixteen combinations of the azimuth θ1 and the azimuth θ2. That is, the second calculation method calculates a Mueller matrix by measuring four polarization element units 72A to 72D. The first calculation method described above can determine all components of a Mueller matrix by performing measurement under at least four combination out of the sixteen combinations of the azimuth θ1 and the azimuth θ2. However, the first calculation method cannot avoid selecting inappropriate combinations which will produce a large calculation error. For example, consider a case that the azimuth θ4 (=Θ) of the prism-type polarizer 63 in the polarization monitor 60 is fixed at the 0° direction and the illumination light L2 is unpolarized light. In this case, the (Expression 13) can be rewritten into the following (Expression 32), (Expressions 33).

$$\begin{matrix}{H}_{j} ( ϕ ) = {a}_{j} + {b}_{j} cos 4 ϕ + {c}_{j} sin 4 ϕ + {d}_{j} cos 2 ϕ + {e}_{j} sin 2 ϕ & ( Expression 32 ) \\ {a}_{j} = {m}_{0 j} + \frac{{m}_{1 j}}{2} cos 2 Θ + \frac{{m}_{2 j}}{2} sin 2 Θ \\ {b}_{j} = \frac{{m}_{1 j}}{2} cos 2 Θ - \frac{{m}_{2 j}}{2} sin 2 Θ \\ {c}_{j} = \frac{{m}_{1 j}}{2} cos 2 Θ + \frac{{m}_{2 j}}{2} sin 2 Θ \\ {d}_{j} = {m}_{3 j} sin 2 Θ \\ {e}_{j} = - {m}_{3 j} cos 2 Θ & ( Expressions 33 )\end{matrix}$$

The Stokes parameter of the illumination light L2 is represented by the following (Expression 33).

$$S = ( \begin{matrix}{s}_{0} \\ {s}_{1} \\ {s}_{2} \\ {s}_{3}\end{matrix} ) = ( \begin{matrix}{s}_{0} \\ 0 \\ 0 \\ 0\end{matrix} ) \qquad ( Expression 34$$

In this case, if the measurement is performed by selecting four or more combinations of the azimuth θ1 and the azimuth θ2 while using only the thin-plate polarizers 726a and 726c having the azimuth θ1 of 0° and 90°, the coefficients of H₂(j) result in significantly smaller values than those in the others, which means that the calculation accuracy is low. Likewise, if the measurement is performed by selecting four or more combinations of the azimuth θ1 and the azimuth θ2 while using only the thin-plate polarizers 726b and 726d having the azimuth θ1 of 45° and −45°, the accuracy of H₁(j ) is low. If the measurement is performed by selecting four or more combinations of the azimuth θ1 and the azimuth θ2 while using only the wide viewing-angle quarter-wavelength plates 725a and 725c having the azimuth θ2 of 0° and 90°, the coefficients of both H₁(j) and H₂(j) become substantially zero, with low calculation accuracy. If the measurement is performed by selecting four or more combinations of the azimuth θ1 and the azimuth θ2 while using only the wide viewing-angle quarter-wavelength plates 725b and 725d having the azimuth θ2 of 45° and −45°, H₁(j) and H₃(j) are not independent, which means that both of them include a large error. Hence, in order to determine all the components of a Mueller matrix accurately without fail in all cases, it is necessary to perform measurement under all of the sixteen combinations of the azimuth θ1 and the azimuth θ2 provided for the polarization evaluation mask 70,

Hence, the second calculation method determines the components of a Mueller matrix analytically by using all the results of measurement performed under the sixteen combinations . First, the (Expression 12) is rewritten into the following (Expression 35).

$${I}_{θ2 , θ1} ( ϕ ) = \frac{1}{4} [ \begin{matrix}{U}_{θ2 , θ1} + {V}_{θ2 , θ1} cos 2 ϕ + {W}_{θ2 , θ1} sin 2 ϕ + \\ {X}_{θ2 , θ1} cos 4 ϕ + {Y}_{θ2 , θ1} sin 4 ϕ\end{matrix} ] \qquad ( Expression 35 )$$

The coefficients indicated in the (Expression 35) have the relationships represented by the following (Expressions 36).

U_{θ2,θ1}α_{θ2,θ1}·α₀+β_{θ2,θ1}·α₁+γ_{θ2,θ1}·α₂+κ_{θ2,θ1}·α₃

V_{θ2,θ1}=α_{θ2,θ1}·b₀+β_{θ2,θ1}·b₁+γ_{θ2,θ1}·b₂+κ_{θ2,θ1}·b₃

W_{θ2,θ1}=α_{θ2,θ1}·c₀+β_{θ2,θ1}·c₁+γ_{θ2,θ1}·c₂+κ_{θ2,θ1}·c₃

X_{θ2,θ1}=α_{θ2,θ1}·d₀+β_{θ2,θ1}·d₁+γ_{θ2,θ1}·d₂+κ_{θ2,θ1}·d₃

Y_{θ2,θ1}=α_{θ2,θ1}·e₀+β_{θ2,θ1}·e₁+γ_{θ2,θ1}·e₂+κ_{θ2,θ1}·e₃ (Expressions 36)

Next, under each combination of the azimuth θ1 and the azimuth θ2, the light intensity I_{θ1,θ2}(j) at the detector 64 is measured at plural values of the angle j at constant angular intervals in accordance with a rotating retarder method. Then, based on the results of the measurement, U_{θ2,θ1}, V_{θ2,θ1}, W_{θ2,θ1}, X_{θ2,θ1}, and Y_{θ2,θ1} under each combination of the azimuth θ1 and the azimuth θ2 are calculated by using Fourier analysis. Next, least squaring is performed based on U_{θ2,θ1}, V_{θ2,θ1}, W_{θ2,θ1}, X_{θ2,θ1}, and Y_{θ2,θ1} obtained under the sixteen combinations to calculate the coefficients aⱼ, bⱼ, cⱼ, dⱼ, and eⱼ. Hence, all the components of a Mueller matrix can be determined.

Specifically, three matrices G, U, and A are defined as represented by the following (Expression 37) to (Expression 39). [αβ] is the sum of α_{q2,q1}×β_{q2,q1} for the sixteen combinations and has a relationship represented by the following (Expression 40).

$$\begin{matrix}G = ( \begin{matrix}[ αα ] & [ αβ ] & [ αγ ] & [ ακ ] \\ [ βα ] & [ ββ ] & [ βγ ] & [ βκ ] \\ [ γα ] & [ γβ ] & [ γγ ] & [ γκ ] \\ [ κα ] & [ κβ ] & [ κγ ] & [ κκ ]\end{matrix} ) & ( Expression 37 ) \\ U = ( \begin{matrix}[ α U ] & [ α V ] & [ α W ] & [ α X ] & [ α Y ] \\ [ β U ] & [ β V ] & [ β W ] & [ β X ] & [ β Y ] \\ [ γ U ] & [ γ V ] & [ γ W ] & [ γ X ] & [ γ Y ] \\ [ κ U ] & [ κ V ] & [ κ W ] & [ κ X ] & [ κ Y ]\end{matrix} ) & ( Expression 38 ) \\ A = ( \begin{matrix}{a}_{0} & {b}_{0} & {c}_{0} & {d}_{0} & {e}_{0} \\ {a}_{1} & {b}_{1} & {c}_{1} & {d}_{1} & {e}_{1} \\ {a}_{2} & {b}_{2} & {c}_{2} & {d}_{2} & {e}_{2} \\ {a}_{3} & {b}_{3} & {c}_{3} & {d}_{3} & {e}_{3}\end{matrix} ) & ( Expression 39 ) \\ [ a β ] = {\sum }_{θ2 , θ1} {α}_{θ2 , θ1} {β}_{θ2 , θ1} & ( Expression 40 )\end{matrix}$$

By providing these definitions, it is possible to establish a normal equation “U=GA”. That is, by deriving the inverse matrix of the matrix G, it is possible to calculate all i the components of the matrix A simultaneously in accordance with the following (Expression 41).

A=G⁻¹U (Expression 41)

Then, the (Expression 41) is assigned to the (Expressions 30) to determine all the components of a Mueller matrix M.

### ADVANTAGES

According to the present embodiment, by providing the polarization evaluation mask 70 on the photomask stage 30 and measuring the light intensity by the polarization monitor 60, it is possible to perform measurement of the Mueller matrix (polarization property) of the projection lens 40 easily.

The polarization evaluation mask 70 has sixteen windows W arranged in line in the scan direction, which are each provided with a different combination of the azimuth θ1 of the thin-plate polarizers 726a to 726d and the azimuth θ2 of the wide viewing-angle quarter-wavelength plates 725a to 725d. This enables measurement for the sixteen combinations to be performed at the same image heights constantly, and realizes highly reliable measurement with no measurement error due to difference of the image heights.

Each of the thin-plate polarizers 726a to 726d is designed in a smaller size than the wide viewing-angle quarter-wavelength plates 725a to 725d. This reduces the mass and volume of the thin-plate polarizers 726a to 726d, which are made of very breakable calcite, and hence enables to protect them from breakage due to shocks or thermal expansion.

### OTHER EMBODIMENTS

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

For example, the wide viewing-angle quarter-wavelength plates 725a to 725d may be made of a combination of any optical materials, as long as the materials have sufficient transmittance to a wavelength of 193 nm and are a combination of a positive uniaxial crystal and a negative uniaxial crystal. Furthermore, the wide viewing-angle quarter-wavelength plates 725a to 725d are not limited to a combination of a positive uniaxial crystal and a negative uniaxial crystal, and need only to finally produce a retardation of approximately 90° through the total of four crystal plates including a combination of two plates and another two plates.

What is claimed is:

1. A polarization evaluation mask for evaluating a polarization state of a projection lens in an exposure device, the mask being disposed upstream of the projection lens with respect to an illumination light thereof, the mask comprising:
a transparent substrate;
a light shielding portion formed on the transparent substrate and having a plurality of openings therein;
a plurality of quarter-wavelength plates formed to cover at least one of the openings, fast axes of the quarter-wavelength plates being different in azimuth by a certain angle; and
a plurality of polarizers disposed upstream of the quarter-wavelength plates with respect to the illumination light and formed to overlay the quarter-wavelength plates and cover at least one of the openings, transmission axes of the polarizers being different in azimuth by a certain angle,
the plurality of openings being provided with different combinations of an azimuth of the polarizer and an azimuth of the quarter-wavelength plate from one another.

2. The polarization evaluation mask according to claim 1,
wherein the plurality of polarizers provide four azimuths different from one another by 45°,
the plurality of quarter-wavelength plates provide four azimuths different from one another by 45°; and
the openings include sixteen openings, and the sixteen openings have different combinations of an azimuth of the polarizer and an azimuth of the quarter-wavelength plate from one another.

3. The polarization evaluation mask according to claim 1,
wherein the plurality of openings are arranged in line at a predetermined pitch.

4. The polarization evaluation mask according to claim 1,
wherein the transparent substrate is made of quartz, and
the light shielding portion is made of chromium.

5. The polarization evaluation mask according to claim 1,
wherein the quarter-wavelength plates include:
a first wavelength plate including a positive uniaxial crystal; and
a second wavelength plate including a negative uniaxial crystal.

6. The polarization evaluation mask according to claim 5,
wherein the first wavelength plate is made of crystallized quartz, and
the second wavelength plate is made of lanthanum fluoride.

7. The polarization evaluation mask according to claim 6,
wherein the polarizers are made of calcite.

8. The polarization evaluation mask according to claim 1, further comprising:
a substrate having a plurality of through holes; and
a plurality of polarization element units fitted inside the through holes respectively,
wherein each of the polarization element units includes the transparent substrate, the light shielding portion, at least one of the quarter-wavelength plates, and plural ones of the polarizers.

9. The polarization evaluation mask according to claim 8,
wherein the light shielding portion is formed in a shape of a rectangular plate, and has plural ones of the openings, the plural ones of the openings being arranged in line in a longer direction thereof, and
the plurality of polarization element units each has the light shielding portion, and are disposed to locate the plural of the openings in line.

10. An exposure device, comprising: a projection lens; and a polarization evaluation mask disposed upstream of the projection lens with respect to an illumination light thereof to evaluate a polarization state of the projection lens,
the polarization evaluation mask including:
a transparent substrate;
a light shielding portion formed on the transparent substrate and having a plurality of openings therein;
a plurality of quarter-wavelength plates formed to cover at least one of the openings, fast axes of the quarter-wavelength plates being different in azimuth by a certain angle; and
a plurality of polarizers disposed upstream of the quarter-wavelength plates with respect to the illumination light and formed to overlay the quarter-wavelength plates and cover at least one of the openings/ transmission axes of the polarizers being different in azimuth by a certain angle,
the plurality of openings being provided with different combinations of an azimuth of the polarizer and an azimuth of the quarter-wavelength plate from one another.

11. The exposure device according to claim 10,
wherein the plurality of polarizers provide four azimuths different from one another by 45°,
the plurality of quarter-wavelength plates provide four azimuths different from one another by 45°; and
the openings include sixteen openings, and the sixteen opening have different combinations of an azimuth of the polarizer and an azimuth of the quarter-wavelength plate from one another.

12. The exposure device according to claim 10,
wherein the plurality of openings are arranged in line at a predetermined pitch.

13. The exposure device according to claim 10,
wherein the transparent substrate is made of quartz, and
the light shielding portion is made of chromium.

14. The exposure device according to claim 10,
wherein the quarter-wavelength plates include:
a first wavelength plate including a positive uniaxial crystal; and
a second wavelength plate including a negative uniaxial crystal.

15. The exposure device according to claim 14,
wherein the first wavelength plate is made of crystallized quartz, and
the second wavelength plate is made of lanthanum fluoride.

16. The exposure device according to claim 15,
wherein the polarizers are made of calcite.

17. The exposure device according to claim 10, further comprising:
a substrate having a through hole; and
a polarization element unit fitted inside the through hole,
wherein the polarization element unit includes the transparent substrate, the light shielding portion, at least one of the quarter-wavelength plates, and plural ones of the polarizers.

18. The exposure device according to claim 17,
wherein the light shielding portion is formed in a shape of a rectangular plate, and has plural ones of the openings, the plural ones of the openings being arranged in line in a longer direction thereof, and
the plurality of polarization element units each has the light shielding portion, and are disposed to locate the plural of the openings in line.

19. A polarization evaluation method of evaluating a polarization state of a projection lens of an exposure device, comprising:
positioning a light shielding portion having an opening, a quarter-wavelength plate to cover the opening, and a polarizer to be overlaid on the quarter-wavelength plate from a downstream side of illumination light, at closer positions to the illumination light than the projection lens is;
changing an azimuth of a fast axis of the quarter-wavelength plate and an azimuth of a transmission axis of the polarizer at predetermined angular intervals to generate plural combinations of the azimuths, and measuring an intensity of light obtained by letting the illumination light transmit through the polarizer under each of the combinations; and
calculating a Mueller matrix based on the intensities.

20. The polarization evaluation method according to claim 19,
wherein the plurality of polarizers provide four azimuths different from one another by 45°,
the plurality of quarter-wavelength plates provide four azimuths different from one another by 45°; and
the openings include sixteen openings, and the sixteen openings have different combinations of an azimuth of the polarizer and an azimuth of the quarter-wavelength plate from one another.
